(19) United States
(12) Patent Application Publication
(10) Pub. No.: US 2004/0235485 A1
(43) Pub. Date: Nov. 25, 2004

(54) Wireless LAN system and channel allocation method

(75) Inventor: Mikihiro Tanaka, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/763,817

(22) Filed: Jan. 23, 2004

(30) Foreign Application Priority Data
Jan. 23, 2003 (JP) 2003-014288

(51) Int. Cl. H04Q 7/20

(52) U.S. Cl. 455/447

(57) ABSTRACT

A method for allocating an frequency band to a wireless communication system, comprising the steps of: detecting frequencies being used by the other wireless systems to search an idle frequency band adapted to a new occupied band to be allocated from among idle frequency bands; deciding a main frequency of the occupied band within the detected idle frequency band; and repeating the detection of the idle frequency band and the decision of the main frequency for the occupied band with a reduced width when there is no idle frequency band adapted to the occupied band and if the width of the occupied band to be set is changeable.

### BACKGROUND OF THE INVENTION

(1) Field of the Invention

The present invention relates to a wireless communication system and, more particularly, to a spread spectrum wireless communication system of a direct sequence type which is suited to effectively using a limited frequency band among a plurality of wireless communication systems and to a control program.

(2) Description of Related Art

At present, the introduction of a wireless LAN in accordance with the IEEE 802.11b standard into an ordinary office is proceeding so that, even in a public area, communication service in a new business model using the wireless LAN is being developed. Besides the wireless LAN, a new wireless communication interface such as, e.g., Bluetooth is showing a sign of prevalence. Under a situation in which numerous wireless devices using the same frequency band are used in areas in relatively close proximity, the avoidance of interference between radio signals and the effective use of the limited frequency band are important tasks to be achieved.

It has been known that, in a wireless communication system using a spread spectrum technology for radio signals, an occupied bandwidth is changed dynamically in accordance with the condition of interference between the radio signals.

For example, it is proposed in Japanese Unexamined Patent Publication No. HEI 5-219008 that, in a spread spectrum communication system of the direct sequence type or a frequency hopping type, a spread bandwidth or hopping bandwidth is set to be large in a line with large interference and the spread bandwidth or the hopping bandwidth is set to be small in a line with small interference. The changing of the spread bandwidth or the hopping bandwidth is performed by switching the chip rate or cycle of a spreading code (Pseudo-Random Noise: PN Code).

It is proposed in Japanese Unexamined Patent Publication No. HEI 6-14006 that, in a spread spectrum communication system, a bandwidth is enlarged by raising the clock rate of a spreading code (Pseudo-Random Noise: PN Code) when the amount of communication has increased or transmission quality has lowered and the bandwidth is narrowed by reducing the clock rate when the amount of communication has decreased or the transmission quality is high.

On the other hand, it is proposed in Japanese Unexamined Patent Publication No. 2002-217918 that, in a wireless communication system in which a plurality of wireless facilities (radio base stations) performing spectrum spreading of the direct sequence type are connected to a single wired LAN, a radio base station to be newly operated detects radio waves currently used by other surrounding radio base stations and sets a band to be occupied thereby to an idle frequency band not used by any of the other radio base stations so as to avoid signal interference between the radio base stations. In the third Patent Document mentioned above, however, a frequency band usable by the wireless communication system is divided into a plurality of fixed width bands (channels) and each of the radio base stations selects a frequency band in an idle state from among these channels.

### SUMMARY OF THE INVENTION

If a plurality of wireless LAN communication systems in accordance with the IEEE 802.11b standard, each of which is comprised of a server station operating as an access point and a plurality of client terminals, are placed at positions in relatively close proximity, it is necessary to set the channel of each access point such that signal interference does not occur between the wireless communication systems. However, the number of wireless LAN channels in accordance with the IEEE 802.11b standard is only 14 in Japan. If interference between wireless communication systems in close proximity is to be avoided completely, the maximum number of available channels is only 4 (1 ch, 6 ch, 11 ch, and 14 ch). In this case, the respective radio signal spectra of the individual channels and the channel spacings are fixed, which prevents effective use of the limited frequency band.

In each of the conventional spread spectrum communication systems shown by Japanese Unexamined Patent Publication Nos. HEI 5-219008 and HEI 6-14006, the bands currently in use are dynamically changed in accordance with a communication situation and neither of them has set a new communication band at an optimum position in an idle band. Japanese Unexamined Patent Publication No. 2002-217918 discloses a technology for setting a new communication band to an idle band which does not interfere with any of the other communication systems under operation. However, the technology assumes the setting of fixed bandwidth channels and does not allow the setting of variable bandwidth channels responsive to a user request.

It is therefore an object of the present invention to provide a wireless communication system, a frequency band allocation method and a control program which allow the setting of variable bandwidth channels responsive to a user request by avoiding the interference of radio signals among a plurality of wireless communication systems.

Another object of the present invention is to provide a spread spectrum wireless communication system, a frequency band allocation method and a control program wherein a plurality of wireless communication systems permit a new communication band to be set in a limited frequency band, while adjusting their occupied bandwidths.

Still another object of the present invention is to provide a spread spectrum wireless communication system, a frequency band allocation method and a control program which allow, even when there is no idle frequency band adapted to a new communication band in a usable frequency space, the preparation of an idle frequency band adapted to the communication band in cooperation with other wireless communication systems.

To attain the foregoing objects, a wireless communication system according to the present invention is comprised of first means for searching, within a predetermined frequency region divided into a plurality of reference frequencies, reference frequencies currently used by other wireless systems located in the surroundings to specify idle state reference frequencies, second means for detecting, from among idle frequency bands each formed of a group of idle state reference frequencies adjacent to each other, an idle frequency band adapted to an occupied band to be newly allocated and deciding the main frequency of the occupied band from among the reference frequencies in the detected idle frequency band, and third means for causing, when there is no idle frequency band adapted to the occupied band and if the width of the occupied band is changeable, the second means to detect the idle frequency band and determine the main frequency of the occupied band for a reduced width occupied band as an object to be allocated.

More specifically, the wireless communication system according to the present invention acquires information on the occupied bandwidths in use from the other wireless communication systems located in the surroundings, excludes reference frequencies included in the occupied bandwidths of the other wireless communication systems from the idle state reference frequencies specified by the first means, and detects an idle frequency band adapted to the occupied band to be newly allocated from among idle frequency bands each composed of a group of the remaining reference frequencies in the idle state.

A feature of the wireless communication system according to the present invention resides in the provision of means for enlarging the width of the idle frequency band, when there is no idle frequency band adapted to the occupied band to be allocated, by shifting the main frequency of the occupied band of any of the other wireless communication systems located in the surroundings. According to an embodiment of the present invention, if there is no idle frequency band adapted to the occupied band, the changeable occupied bandwidth currently used by any of the other wireless communication systems located in the surroundings is reduced and the main frequency thereof is shifted, whereby the width of the idle frequency band is further enlarged.

When the occupied band width in use and the main frequency thereof are changed as described above, the wireless communication system according to the present invention notifies the other wireless communication systems of the results of the changes. The wireless communication system according to the present invention also preliminarily holds plural types of spreading codes with different chip rates in correspondence with the widths of the changeable occupied bands and performs transmission and reception of radio signals based on the spreading code corresponding to the allocated occupied bandwidth and on the determined main frequency.

A frequency band allocation method and a control program for the wireless communication system according to the present invention comprises: a first step of searching, within a predetermined frequency region divided into a plurality of reference frequencies, the reference frequencies currently used by other wireless systems located in the surroundings and creating a reference frequency table indicative of relationships between the reference frequencies and the use situations thereof; a second step of acquiring information on an occupied bandwidth in use from each of the other wireless communication systems located in a communicative range and creating a band-in-use management table indicative of a relationship between the occupied bandwidth and the main frequency thereof for each of the wireless communication systems; a third step of creating, based on the reference frequency table and the band-in-use management table, an idle band management table indicative of relationships between groups of idle state reference frequencies adjacent to each other and idle frequency bands composed of the respective groups of the idle state reference frequencies; and a fourth step of detecting, from the idle band management table, one of the idle frequency bands adapted to an occupied band to be newly allocated and deciding the main frequency of the occupied band from among the reference frequencies in the detected idle frequency band, the fourth step being repeated for a reduced width occupied band as an object to be allocated when there is not idle frequency band adapted to the occupied band and if the width of the occupied band is changeable.

These and other objects and features of the present invention will become apparent from the embodiments thereof which will be described herein below.

### BRIEF DESCRIPTION OF THE DRAWINGS

FIG. 1 is a view for explaining an environment in which wireless communication systems 1A and 1B according to the present invention are placed;

FIG. 2 is a view showing an embodiment of a server radio station 10A according to the present invention;

FIG. 3 is a view showing an example of a reference frequency table 17 provided in the server radio station 10A;

FIG. 4 is a view showing an example of a server bandwidth-in-use management table 18 provided in the server ratio station 10A;

FIG. 5 is a view showing an example of an idle bandwidth management table 19 provided in the server radio station 10A;

FIG. 6 is a view showing a relationship between a main frequency fi and an occupied bandwidth W in a spread-spectrum radio signal spectrum CHi of a direct sequence type;

FIG. 7 is a block diagram of a spread spectrum modulator/demodulator unit 12B of the direct sequence type;

FIGS. 8A and 8B are views each showing a relationship between transmission data DATA and a spreading code “rs”;

FIGS. 9A to 9C are views for explaining a relationship between the chip rate of a spreading code and an occupied bandwidth;

FIG. 10 is a flow chart showing an embodiment of a control routine 100 to be executed by the server radio station 10A;

FIG. 11 is a detailed flow chart showing an embodiment of a rough search process 110 in the control routine 100;

FIG. 12 is a view showing an example of a result of measuring the intensity of a received signal in the rough search process 110;

FIG. 13 is a detailed flow chart showing an embodiment of a minute search process 120 in the control routine 100;

FIG. 14 is a view showing an example of a parameter setting screen displayed on a server management terminal;

FIG. 15 is a detailed flow chart showing an embodiment of a main frequency setting process 160 in the control routine 100;

FIG. 16 is a detailed flow chart showing an embodiment of an occupied bandwidth adjustment process 170 in the main frequency setting process 160;

FIG. 17 is a detailed flow chart showing an embodiment of a frequency band adjustment process 180 in the occupied bandwidth adjustment process 170;

FIGS. 18A to 18C are views showing changes in occupied bands and main frequencies which shift with the execution of the frequency band adjustment process 180;

FIG. 19 is a view showing an example of the allocation of occupied bands in the wireless communication system according to the present invention;

FIG. 20 is a block diagram showing an embodiment of a client terminal 40A; and

FIG. 21 is a flow chart showing an embodiment of a control routine to be executed by the client terminal 40A.

### DESCRIPTION OF THE PREFERRED EMBODIMENTS

Referring to the drawings, the embodiments of the present invention will be described herein below.

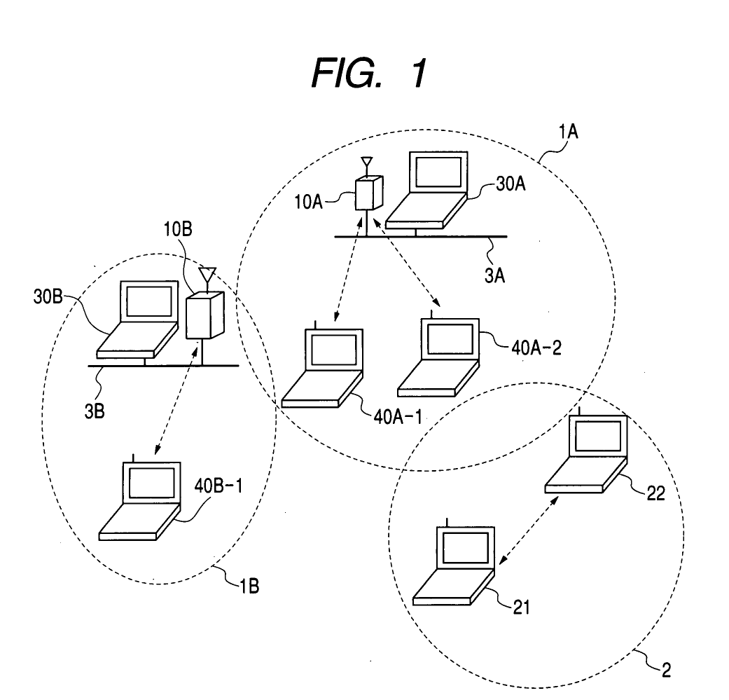

FIG. 1 shows a state in which a plurality of wireless communication systems are placed in close proximity on the same floor. In the drawing, 1A and 1B denote wireless communication systems having a spread spectrum communication function of a DS (Direct Sequence) type according to the present invention and 2 denotes a wireless communication system of a type different from that of the present invention. The wireless communication system 2 is constituted by a server station 21 and a client terminal 22 each having a wireless communication function.

The wireless communication system 1A is comprised of a server radio station 10A; a server management terminal (information processor) 30A connected to the server radio station 10A via a wired LAN 3A such as, e.g., Ethernet (registered trademark) and a plurality of client terminals 40 (40A-1, 40A-2, . . . ) which perform wireless communication with the server radio station 10A. Likewise, the wireless communication system 1B is also comprised of a server radio station 10B, a server management terminal (information processor) 30B connected to the server radio station via a wired LAN 3B and client terminals 40 (40B-1, . . . )

The server management terminal 30A (30B) is used to set parameters for specifying a bandwidth to be reserved for the server radio station 10A (10B). The server management terminal 30A (30B) may be connected directly to the server radio station 10A (10B) via a connection line such as, e.g., a USB cable instead of the wired LAN 3A.

The client terminals 40 (40A-1, 4OB-1, . . . ) are information processors each having any wireless communication function such as a personal computer equipped with a wireless LAN card or a mobile information terminal having therein a wireless LAN function.

The server radio station 10A (10B) has an interface for connection with the wired LAN in addition to the function of wireless communication with the client terminals and operates as an access point for mediating communication between the client terminals. When the server radio station 10A according to the present invention starts operation in an environment in which another wireless communication system (e.g. , 1B or 2) is already in an operating state, it selects a proper radio frequency not interfering with the other communication system by using the function of searching a surrounding radio wave, the function of selecting the main frequency of an occupied band, and the function of adjusting the occupied bandwidth, which will be described later.

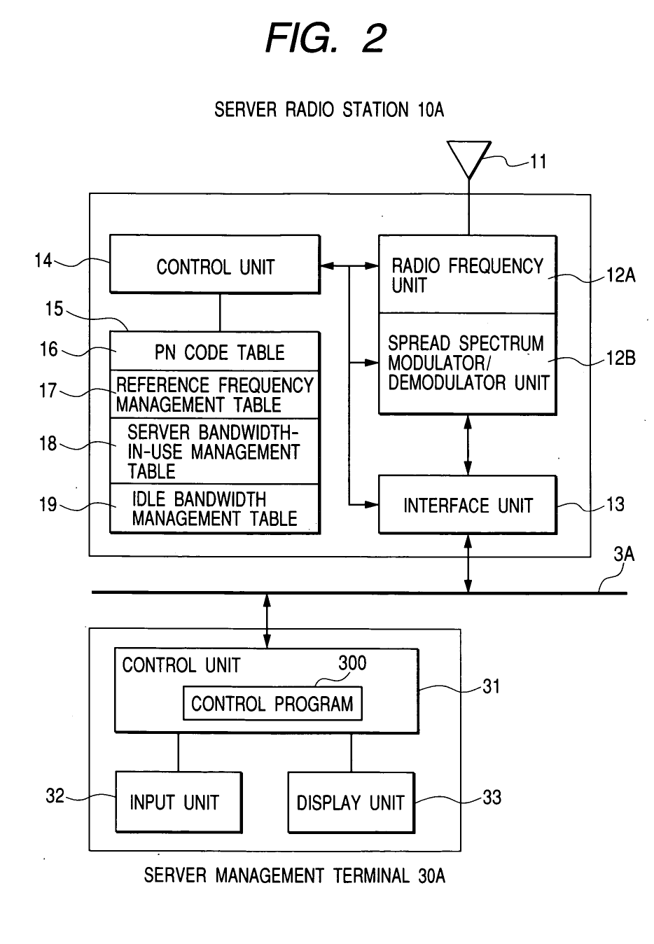

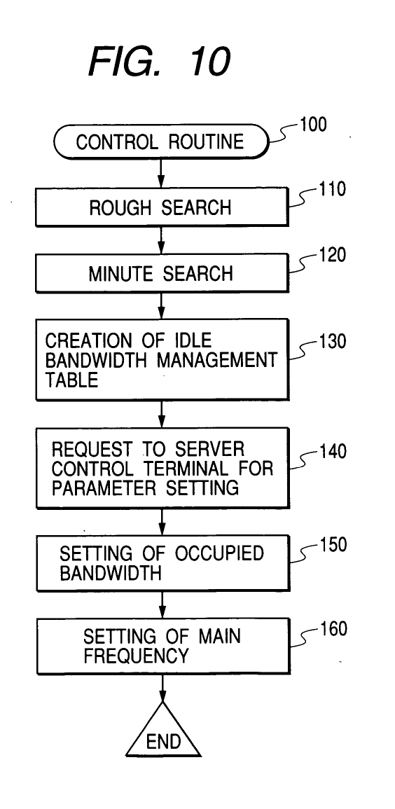

FIG. 2 shows a structure of the server radio station 10B. The server radio station 10A is comprised of an RF unit 12A connected to an antenna 11, a spread spectrum modulator/demodulator unit 12B connected to the RF unit, an interface unit 13 for connection with the LAN 3A, a control unit 14 (control processor) 14 and a memory 15. The control unit 14 searches the use situations of radio signals around the wireless communication system 1A in accordance with the control routine 100 which will be described later with reference to FIG. 10, sets the main frequency of a radio signal to be used in the wireless communication system 1A, and adjusts an occupied bandwidth.

The server management terminal 30A is comprised of a control unit 31, an input unit 32 and a display unit 33. The control unit 31 has a memory in which a program 300 for controlling the server radio station has been installed in addition to normal application routines.

In the memory 16 of the server radio station 10A, a PN code table 16 storing therein spreading codes to be applied to the spread spectrum modulator/demodulator unit 12B, a reference frequency management table 17 to be referenced in the control routine 100, a server bandwidth-in-use management table 18, and an idle bandwidth management table 19 are formed.

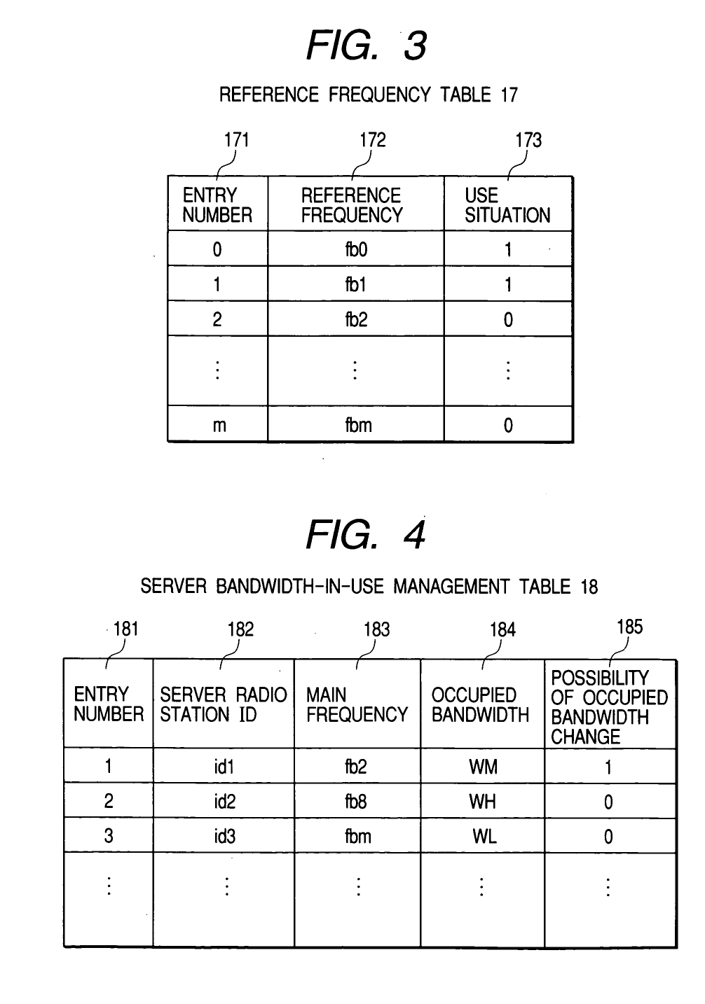

As shown in, e.g., FIG. 3, a plurality of entries having entry numbers 171 are registered in the reference frequency table 17. Each of the entries includes a reference frequency 172 and a flag 173 indicative of the use situation of the reference frequency.

As shown in, e.g., FIG. 4, a plurality of entries having entry numbers 181 are registered in the server bandwidth-in-use management table 18. Each of the entries includes a server radio station ID 182, the main frequency 183 and occupied bandwidth 184 of a radio signal used in the server radio station having the ID, and a flag 185 indicative of whether or not the occupied bandwidth is changeable.

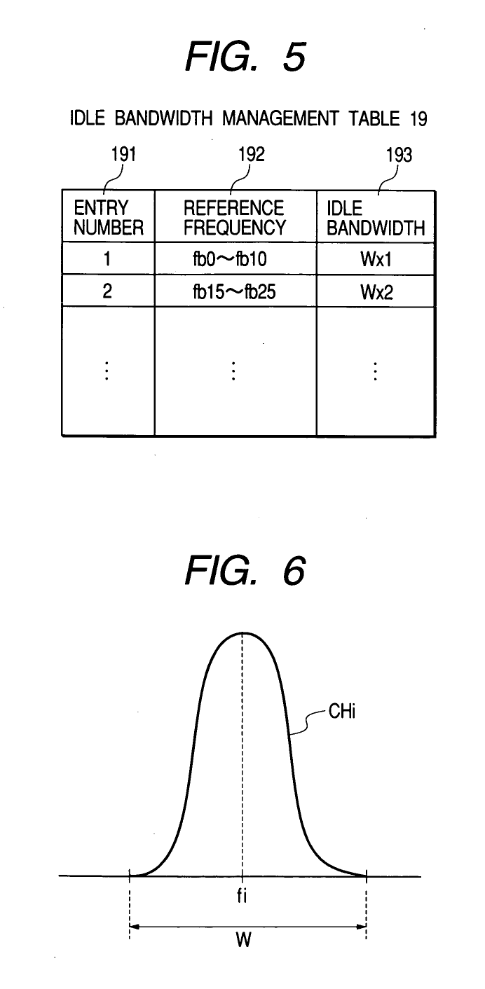

As shown in, e.g., FIG. 5, a plurality of entries having entry numbers 191 are registered in the idle bandwidth management table 19. Each of the entries indicates a relationship between reference frequencies 192 in an idle state and a bandwidth 193. The reference frequencies 192 in the idle state indicate a group of consecutive reference frequencies in the idle state and the bandwidth 193 indicates the value of the bandwidth that can be provided by the group of reference frequencies.

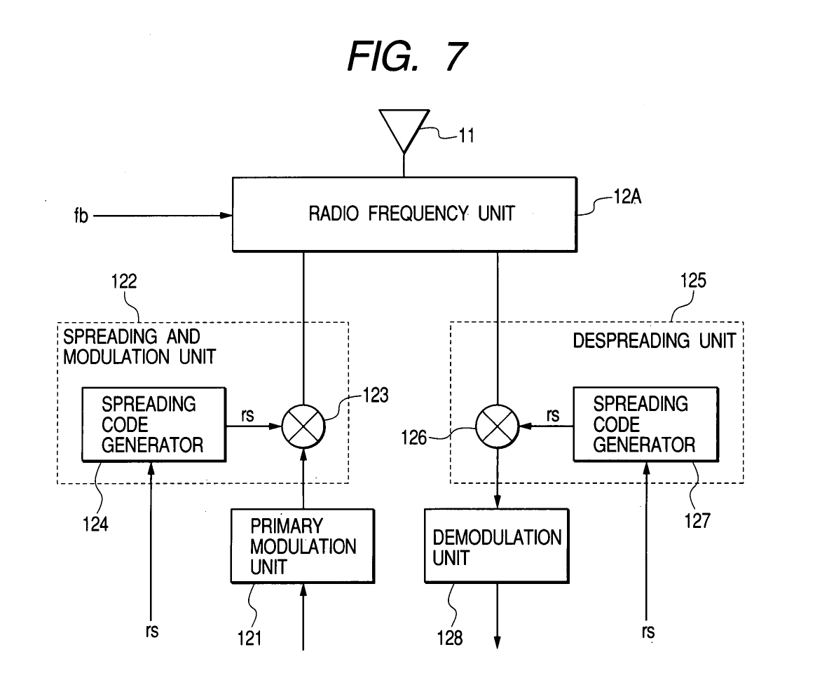

FIG. 6 shows a relationship between a main frequency fi and an occupied bandwidth (main lobe) W in a spread-spectrum radio signal spectrum CHi of the direct sequence type. FIG. 7 is a block diagram of the spread spectrum modulator/demodulator unit 12B of the direct sequence type.

Transmission data is subjected to, e.g., primary modulation according to PSK (Phase Shift Keying) modulation in a primary modulation unit 121 and inputted to a spreading and modulation unit 122. The spreading and modulation unit 122 is composed of an exclusive OR (EXOR) circuit 123 and a spreading code generator 124 and performs spectrum spreading with respect to each bit in the primary modulated transmission data in accordance with a spreading code which is generated from the spreading code generator 124. An output signal from the spreading and modulation unit 122 is inputted to the RF unit 12A where it is superimposed on a carrier signal having the reference frequency specified by the control unit 14 and transmitted from the antenna 11.

On the other hand, the signal received by the RF unit 12A is subjected to spectrum despreading in a despreading unit 125 composed of an EXOR circuit 126 and a spreading code generator 127 and demodulated into received data in a demodulation unit 128.

The spreading codes to be generated from the spreading code generator 124 of the spreading and modulation unit and from the spreading code generator 127 of the despreading unit are selected from the PN code table 16 by the control unit 14 depending on the occupied bandwidth W specified by an operator from the server management terminal 30A and set to the individual spreading code generators.

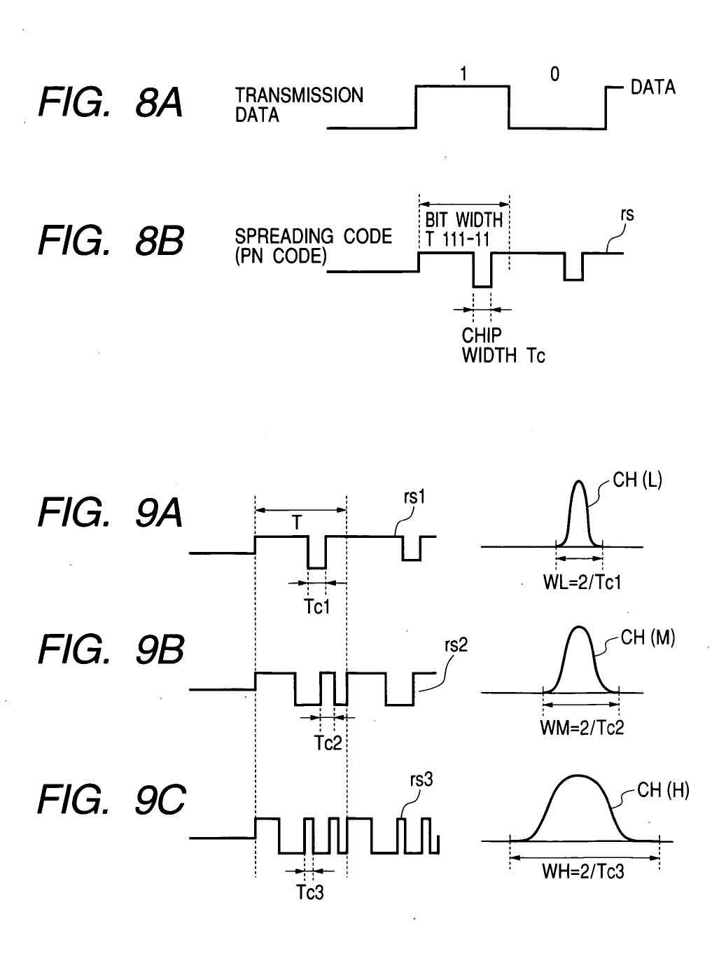

FIGS. 8A and 8B show a relationship between the transmission data and a spreading code.

As shown in FIG. 8B, the spreading code “rs” is an assembly of random rectangular waves having an extremely high-speed chip rate (1/Tc) compared with the bit rate (1/T) of the transmission data DATA shown in FIG. 8A. The spreading code “rs” illustrated herein is composed of five chips having the values of 1, 1, 1, −1, and 1, respectively. The primary modulated data is subjected to an exclusive OR (EXOR) operation with the spreading code rs to have a spectrum spread over a wide band range.. The occupied bandwidth (main lobe) W of the radio signal that has undergone code spreading is double the chip rate of the applied spreading code.

FIGS. 9A to 9C show a relationship between the chip rates of the spreading codes and the occupied bandwidths W.

FIG. 9A shows a 5-chip spreading code rs1 having a chip cycle Tc1 and the occupied bandwidth WL of a radio signal spectrum CH(L) when the 5-chip spreading code rs1 is applied. FIG. 9B shows a 7-chip spreading code rs2 having a chip cycle Tc2 and the occupied bandwidth WM of a radio signal spectrum CH (M) when the 7-chip spreading code rs2 is applied. FIG. 9C shows a 11-chip spreading code rs3 having a chip cycle Tc3 and the occupied bandwidth WL of a radio signal spectrum CH(H) when the 11-chip spreading code rs3 is applied.

One characteristic feature of the present invention is that the occupied bandwidth W is adjusted by changing the chip rate of the spreading code to be applied for the spectrum spreading in the server radio station 10 by using the above relationship between the chip rates of the spreading codes and the occupied bandwidths W. The spreading codes prepared in the PN code table 16 are determined by the types of communication modes selectable in the wireless communication system.

If the types of communication modes selectable in the wireless communication system are limited to three modes which are low-speed, middle-speed, and high-speed communication modes, three different spreading codes shown in FIGS. 9 are prepared in the PN code table 16 so that the 5-chip spreading code rs1, the 7-chip spreading code rs2, and the 11-chip spreading code rs3 are applied for the low-speed, middle-speed, and high-speed communication modes, respectively.

FIG. 10 shows a flow chart of the control routine 100 to be executed by the control unit 14 when the power source of the server radio station 10A is turned on.

In the control routine 100, the control unit 14 first executes a rough search process (110) to search the use situations of surrounding radio signals at a plurality of reference frequencies in a predetermined range and stores the use situation of each of the reference frequencies in the frequency management table 17. In the rough search process, not only the radio frequencies used by other wireless communication systems using the same method (of the same type) as the present invention but also the radio frequency currently used in the wireless communication system 2 of the type different from that of the present invention are detected by successively switching carrier frequencies to be set to the RF unit 12A and checking the presence or absence of a radio wave received from the surroundings at each of the reference frequencies.

When the rough search process (110) is completed, the control unit 14 executes a minute search process (120). In the minute search process, the control unit 14 inquires the other server radio station using the same method as the present invention and located in the surroundings of bandwidth-in-use information including, e.g., the main frequency f0 of the radio signal in use, the occupied bandwidth W thereof, and whether the occupied bandwidth is changeable. The bandwidth-in-use information acquired from each of the server radio stations under operation is registered in the server bandwidth-in-use management table 18.

When the acquisition of the bandwidth-in-use information from all the server radio stations located in the surroundings is completed, the control unit 14 creates, based on the frequency management table 17 and the server bandwidth-in-use management table 18, the idle bandwidth management table 19 indicative of the relationship between a group of reference frequencies in the idle state and the idle bandwidths (130). Thereafter, the control unit 14 requests, of the server management terminal 30A, the setting of parameters for specifying the bandwidth to be reserved for the server radio station 10A (140) and performs the setting of the occupied bandwidth W of the radio signal (150) and the setting of the main frequency (160) based on the parameters specified from the server management terminal 30A.

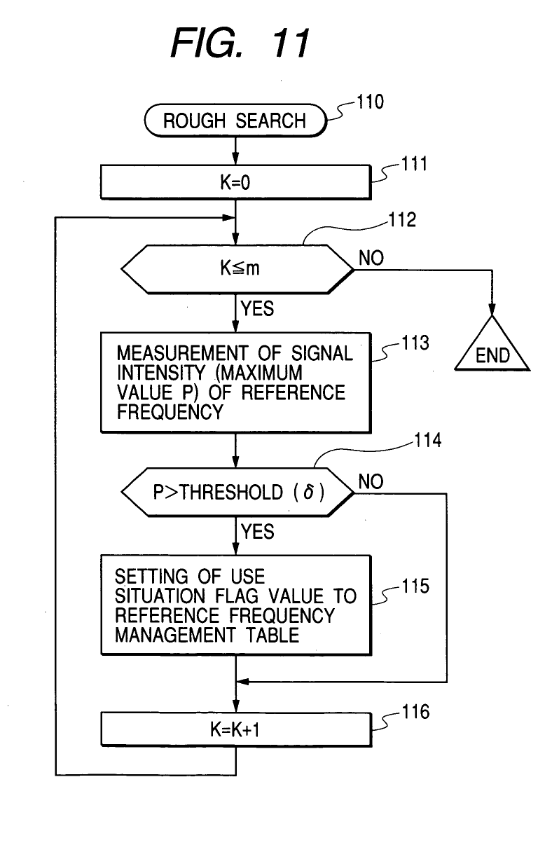

FIG. 11 is a detailed flowchart of the rough search process 110. In the rough search process 110, the control unit 14 sets (111) an initial value 0 to a parameter k for successively switching predetermined reference frequencies fb0 to fbm and compares the parameter k with a maximum value m (112). If k m is satisfied, the control unit 14 adjusts the reception frequency of the RF unit 12A to a k-th reference frequency fbk and measures the intensity of a received radio signal having the frequency fbk for a specified period (113). The control unit 14 compares the maximum value P of the received signal intensity measured in the specified period with a threshold value δ (114). If P>δ is satisfied, a value “1” indicating that the frequency is in use is set to the use situation flag 173 of an k-th entry corresponding to the reference frequency fbk on the reference frequency management table 17 (115). Thereafter, the control unit 14 increments the value of the parameter k (116) and returns to Step 112.

By repeating Steps 112 to 116, the use situation of radio signals in the surroundings of the server radio station can be searched at each of the reference frequencies fb0 to fbm. When the value of the parameter k exceeds m, the rough search process 110 is ended.

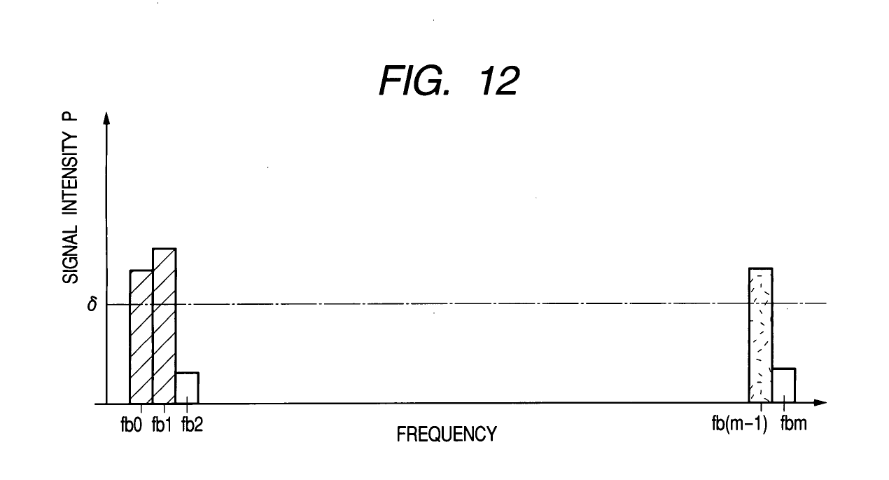

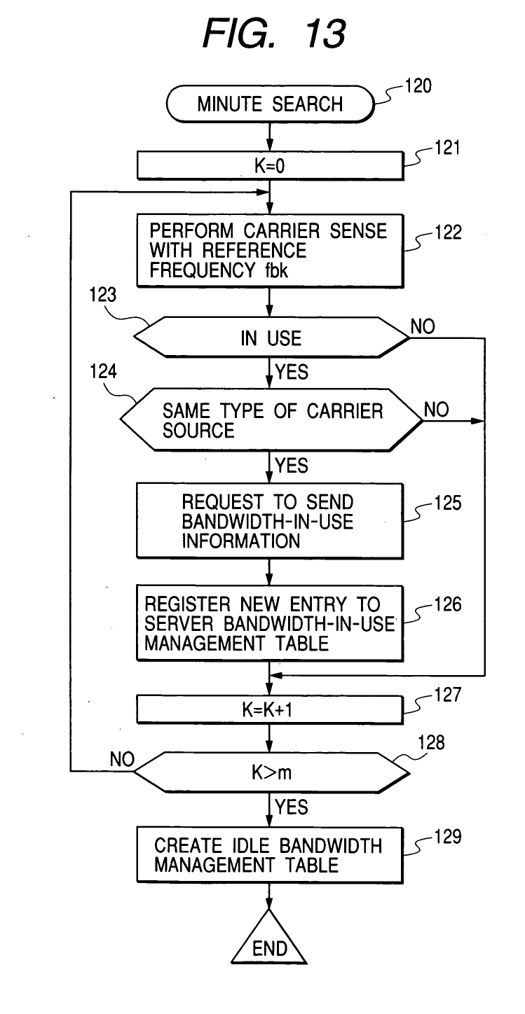

FIG. 12 shows an example of the result of measuring the received signal intensity in the rough search process. The reference frequencies fb0, fb1, . . . and fbm are frequencies determined when a frequency band usable in the wireless communication system according to the present invention is divided into widths corresponding to ½ of the occupied bandwidth WL required in the low-speed communication mode. Here, fb0 indicates a lowest usable reference frequency and fbm indicates a maximum reference frequency.

The flag 173 of each of the entries in the reference frequency management table 17 has an initial value “0” and the flag value “1” is set to the reference frequency in usein accordance with the result of the measurement. It follows therefore that the server radio station 10A selectively obtains, from the reference frequencies each having the flag 173 set in an unused state “0”, the occupied bandwidth specified by the server management terminal and determines the main frequency thereof.

FIG. 13 is a detailed flow chart of the minute search process 120. In the minute search process 120, the control unit 14 sets an initial value 0 to the parameter k for successively switching the reference frequencies fb0 to fmb (121) and performs carrier sensing (122) by adjusting the reception frequency of the RF unit 12A to the k-th reference frequency fbk. If a carrier signal cannot be sensed (123), the control unit 14 increments the value of the parameter k (127) and judges whether k exceeds a maximum value m (128). If k is not more than m, the control unit 14 returns to Step 122 and repeats the same operations at the subsequent reference frequency.

When a carrier having the reference frequency fbk is sensed, the control unit 14 checks whether a source system of the carrier is of the same type as its own system (124). The carrier source system is identified, for example, by attempting to demodulate the received signal, while successively switching the spreading code to be used in the spread spectrum modulator/demodulator unit 12B to the codes for a low speed, a middle speed and a high speed, in a state in which the reception frequency of the RF unit 12A is adjusted to the k-th reference frequency fbk. If the received signal can be demodulated with any of the spreading codes, the control unit 14 judges that the source of the signal is a system of the same type as its own system. If the transmitter is a system of a different type, the control unit 14 proceeds to Step 127.

When the carrier source is a system of the same type as its own system, the control unit 14 performs an interruption process to the carrier source system by using the spreading code with which the received signal was demodulated successfully in Step 124 and sends a request message for requesting transmission of the use situation information (125). The request message is outputted from the control unit 14 to the spread spectrum modulator/demodulator unit 12B and a response message from the carrier source is inputted from the spread spectrum modulator/demodulator unit 12B to the control unit 14.

Upon receiving the response message from the carrier source, the control unit 14 adds a new entry to the server bandwidth-in-use management table 18. The new entry indicates the source server ID, the main frequency, the occupied bandwidth, and whether the occupied bandwidth is changeable, which have been obtained from the response message (126). Thereafter, the control unit 14 increments the value of the parameter k (127) and repeats the operations described above. As for the relationship between the reference frequency and the spreading code that has been determined in Step 124, it is stored in a work table in correspondence with the server ID shown by the response message. Alternatively, the information may be registered in the server bandwidth-in-use management table 18 in Step 126.

When the minute search process 120 is ended, the control unit 14 creates the idle bandwidth management table 19 shown in FIG. 5 (Step 130 of FIG. 10) based on the server bandwidth-in-use management table 18 and on the reference frequency management table 17 created in the minute search process 110. In this case, the control unit 14 calculates the reference frequencies included in the occupied bandwidth from, e.g., the main frequency 183 and the occupied bandwidth 184 each registered in the server bandwidth-in-use management table 18 and changes each of the use situation flags 173 of the entries corresponding to these reference frequencies to “1” on the reference frequency management table 17. Then, the control unit 14 selects idle reference frequencies each having the use situation flag 173 indicating the idle state from the reference frequency management table 17 and divides the selected idle reference frequencies into groups such that each of the groups is composed of the consecutive idle reference frequencies. The control unit 14 creates, for each of the groups of the idle reference frequencies, an entry including the reference frequencies 192 contained in the group and the idle bandwidth 193 calculated from these reference frequencies and registers the created entry in the idle bandwidth management table 19.

In order to completely avoid interferences between radio signals having respective frequencies in close proximity, it is also possible to prohibit the use of reference frequencies adjoining the occupied bandwidth and reduce the number of the idle reference frequencies and the idle bandwidth registered in the idle bandwidth management table 19. For example, if it is recognized that the reference frequencies fb(m−1) fbm, and fb(m+1) are in use on the reference frequency management table 17, it is possible to prohibit the use of the two idle frequencies fb(m−2) and fb(m+2) adjoining these reference frequencies and create each of the entries in the idle bandwidth management table 19 by using the remaining idle reference frequencies.

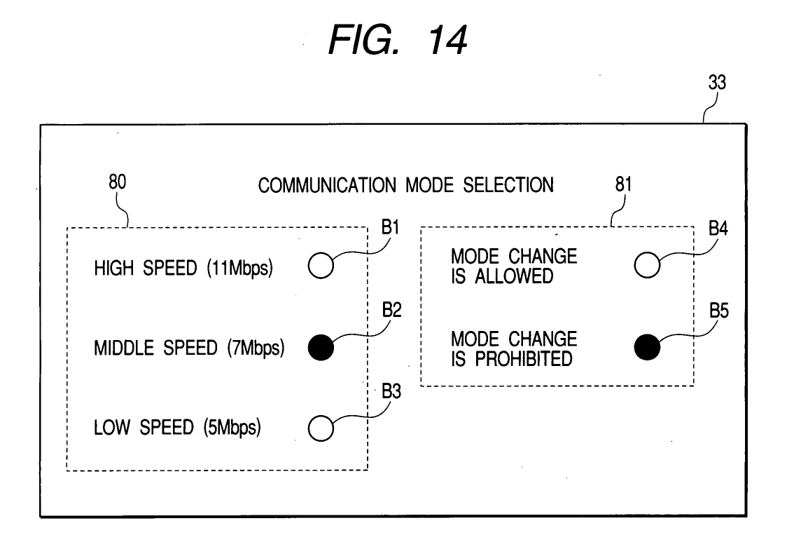

FIG. 14 shows an example of a parameter setting screen displayed on the display unit 33 of the server management terminal 30A in response to a parameter set request (140) from the server radio station 10A.

The parameter setting screen is offered by a control program 300 of the server management terminal 30A. The parameter setting screen shown here includes a communication mode selection window 80 for allowing the selection of one from among the three types of high-speed (11 Mbps), middle-speed (7 Mbps), and low-speed (5 Mbps) communication modes and a window 81 for specifying whether or not a mode change is possible.

A server manager selects a communication mode by clicking any of selection buttons B1 to B3 displayed on the communication mode selection window 80 depending on the communication performance required of the wireless communication system 1A. The server manager also judges whether it permits another server radio station to change the communication mode (occupied bandwidth) of its own and clicks either of buttons B4 and B5 displayed on the mode change Allow/Prohibit selection window 81. When the communication mode and possibility of mode change are determined on the parameter setting screen, the control program 300 creates a control message including these parameters and transmits it to the server radio station 10A.

The illustrated example shows a state in which the server manager has selected the middle-speed mode and specified that the mode is unchangeable. When the server manager has selected the low-speed mode, it is also possible to allow the control program 300 to automatically select the communication mode change prohibit button B5 since there is no communication mode lower than that of the selected mode.

Each of the communication modes specified on the communication mode setting screen indicates a data transmission speed which can be guaranteed when a data transmission error rate is suppressed to a given value or less. In an actual application, various types of data are communicated so that the lowest required data transmission speed differs depending on the type of data to be transmitted or received.

For example, if the high-speed mode is selected for the transmission of text data at 5 Mbps, data transmission excellent in noise immunity can be performed, but the efficiency of a frequency resource usage lowers because the occupied bandwidth is larger than an optimal value. Conversely, if the middle-speed mode is selected for data transmission at 10 Mbps, the occupied bandwidth is reduced to allow effective use of the frequency resource, but the error rate of data transmission is increased, whereby the data transmission speed resultantly lowers. It is therefore desirable for the server manager to select the communication mode in accordance with the type of data to be transmitted and received by the wireless communication system under control such that the frequency resource is used effectively in cooperation with other wireless communication systems operating in the surroundings.

For example, if the server manager selects the high-speed mode (the button B1) at 11 Mbps and the mode change Prohibit mode (the button B5) for communicating image data in the wireless communication system 1A, the occupied bandwidth of the wireless communication system 1A is enlarged so that the frequency resource allocatable to the other wireless communication systems is reduced and the number of systems that can coexist with the wireless communication system 1A is reduced.

When the communication data is text data and the server manager has selected the low-speed mode (the button B3) because a communication speed on the order of 2 Mbps is sufficient, the bandwidth occupied by the wireless communication system 1A is reduced, and the frequency resource allocatable to the other wireless communication systems is increased so that a large number of wireless communication systems can coexist.

Upon receiving a control message including the above parameters from the server management terminal 30A, the control unit 14 of the server radio station 10A selects the occupied bandwidth W with the value (WL, WM, or WH) corresponding to the specified communication mode (150) , as described above with reference to FIGS. 9, and executes the process 160 of setting the main frequency to the occupied bandwidth W.

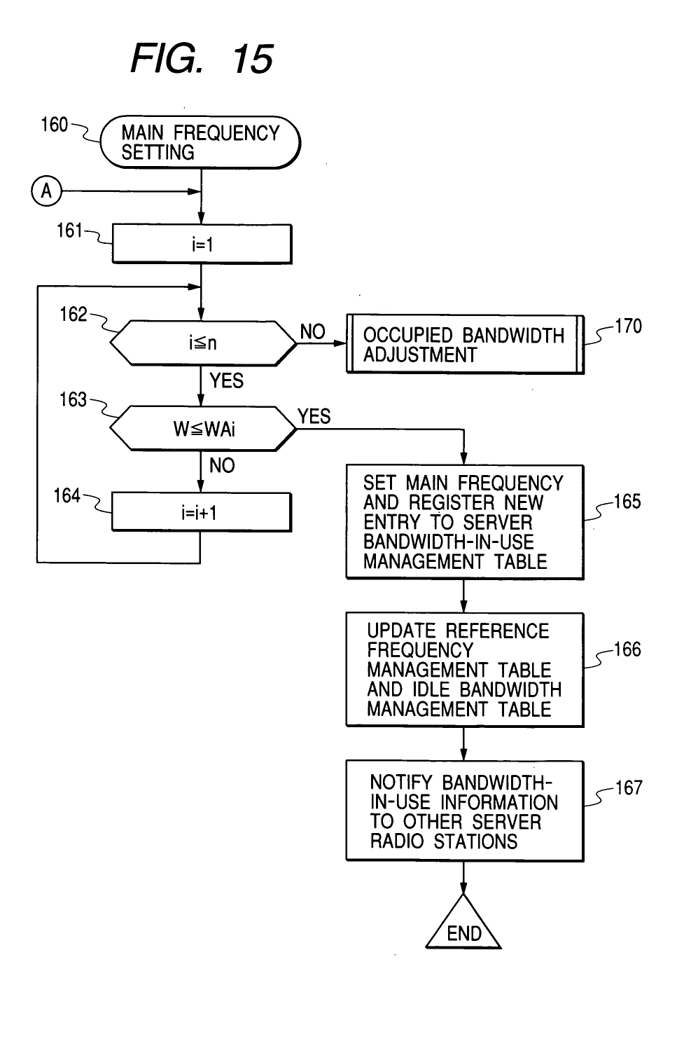

FIG. 15 shows a detailed flow chart of the main frequency setting process 160. In the main frequency setting process 160, the control unit 14 sets (161) an initial value “1” to a parameter i for sequentially reading the registered entries from the idle bandwidth management table 19 and compares (162) the value of the parameter i with the number n of the registered entries in the idle bandwidth management table 19. If the value of the parameter i is not exceeding the number n of the registered entries, the control unit 14 reads out (163) the idle bandwidth (WAi) 193 from the i-th entry in the idle bandwidth management table 19 and compares the idle bandwidth (WAi) 193 with the occupied bandwidth W.

If the idle bandwidth WAi of the i-th entry is smaller than the occupied bandwidth W, the control unit 14 increments the value of the parameter i (164) and returns to Step 162. If the idle bandwidth WAi is not less than the occupied bandwidth W, the control unit 14 selects a standard frequency fbx positioned at the center of the idle frequency band Ai as the main frequency, creates an entry indicative of the identifier (ID) of the server radio station 10A, the main frequency fbx, the occupied bandwidth W, and an occupied bandwidth changeability flag, and registers (165) the created entry in the server bandwidth-in-use management table 18.

The control unit 14 changes the use situation flag 173 of the reference frequency management table 17 to “1” for each of the reference frequencies included in the occupied bandwidth W and adds correction (166) to the corresponding entry in the idle bandwidth management table 19. Thereafter, the control unit 14 notifies (166) all the other server radio stations registered in the server bandwidth-in-use management table 18 of its own server radio station ID, the main frequency fbx, the occupied bandwidth W, and the occupied bandwidth changeability flag and then ends the routine 100.

If all the idle frequency bandwidths (WAi) 193 registered in the server bandwidth-in-use management table 18 are smaller than the occupied bandwidth W, the control unit 14 executes an occupied bandwidth adjustment process (170).

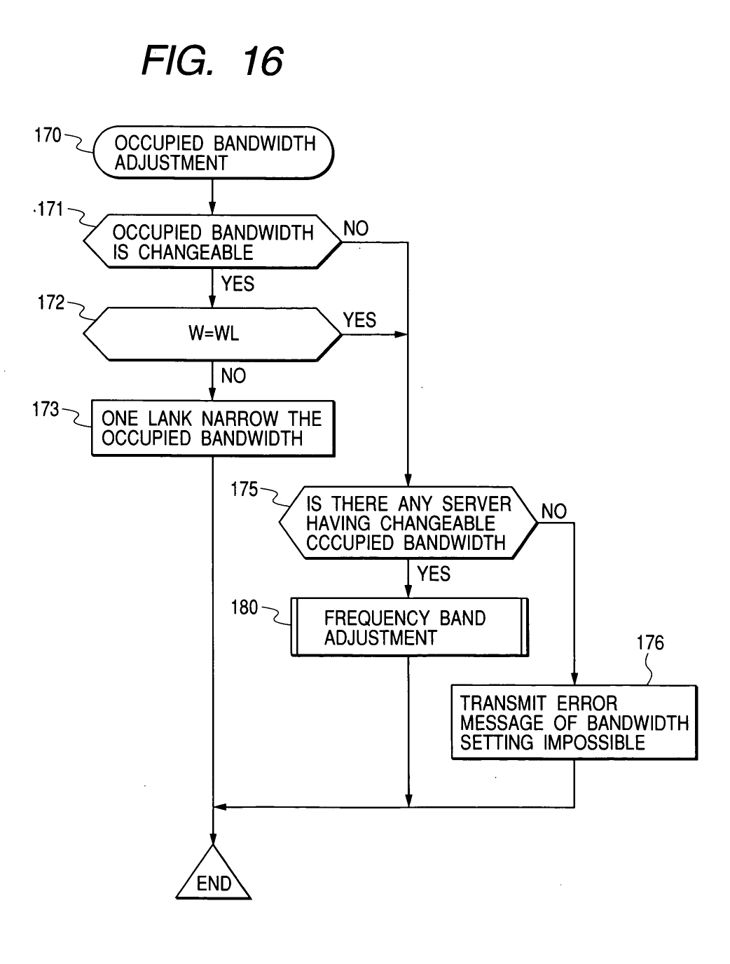

FIG. 16 shows a detailed flow chart of the occupied bandwidth adjustment process 170. In the occupied bandwidth adjustment process 170, the control unit 14 checks (171) whether the occupied bandwidth W of its own server radio station 10A is changeable. If the occupied bandwidth W is changeable, the control unit 14 judges (172) whether the current occupied bandwidth W is a minimum bandwidth WL. If the occupied bandwidth W is not the minimum bandwidth WL, the control unit 14 narrows the occupied bandwidth W by one rank (173) returns to Step 161 of the main frequency setting process 160 shown in FIG. 15, and performs the main frequency setting process 160 again from the beginning. It is to be noted that the changing of the occupied bandwidth W in Step 173 indicates the changing of the occupied bandwidth W to WM if the current bandwidth is WH and the changing of the occupied bandwidth W to WL if the current bandwidth is WM.

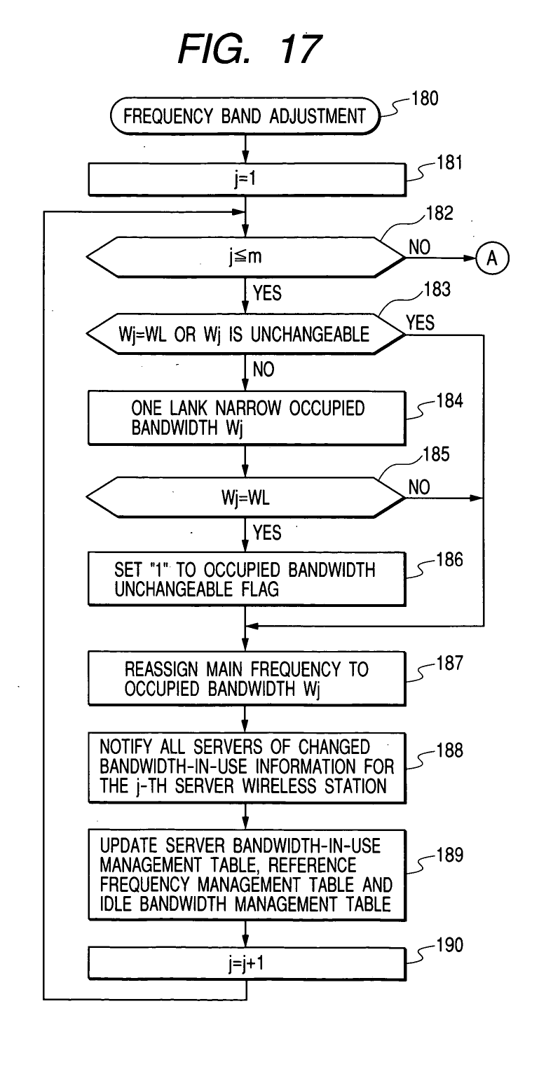

In the occupied bandwidth adjustment process 170, if the occupied bandwidth W of its own server radio station 10A is unchangeable (171) or if the current occupied bandwidth W is the minimum bandwidth WL (172) which cannot be reduced any more, the control unit 14 references the flag 185 indicative of the changeability of the occupied bandwidth in the server bandwidth-in-use management table 18 and checks (175) whether a server radio station having a changeable occupied bandwidth is present in the surroundings. If there is a server radio station having a changeable occupied bandwidth, the control unit 14 executes a frequency band adjustment process 180, which will be described in detail with reference to FIG. 17, and returns to Step 161 of the main frequency setting process 160 shown in FIG. 15 to perform the main frequency setting process 160 again from the beginning. If there is no server radio station having a changeable bandwidth, the control unit 14 transmits an error message indicating that bandwidth setting is impossible to the server management terminal 30A (176) and ends the routine 10.

FIG. 17 shows a detailed flow chart of the frequency band adjustment process 180. In the frequency band adjustment process 180, the control unit 14 sets (181) an initial value “1” to a parameter j for sequentially checking the registered entries in the server bandwidth-in-use management table 18 and judges whether the parameter j is exceeding the number m of the registered entries (182). If the parameter j is not exceeding m, the control unit 14 checks (183) the occupied bandwidth (Wj) 184 and the occupied bandwidth changeability flag 185 of a j-th entry in the server bandwidth-in-use management table 18. If the occupied bandwidth is unchangeable or if the occupied bandwidth Wj is the minimum bandwidth WL, the control unit 14 proceeds to Step 187.

If the occupied bandwidth is changeable and the occupied bandwidth Wj is not the minimum bandwidth WL, the control unit 14 narrows the occupied bandwidth Wj by one rank (184). If the changed occupied bandwidth Wj is the minimum bandwidth WL (185) , the control unit 14 changes the occupied bandwidth changeability flag 185 of the j-th entry to “1” (186) and reallocates the main frequency to the changed occupied bandwidth Wj (187).

The control unit 14 creates a control message indicating that the occupied bandwidth Wj and main frequency have been changed with respect to the server radio station ID 182 of the j-th entry and transmits (188) the control message to all the other server radio stations registered in the server bandwidth-in-use management table 18. The notification of the main frequency change is transmitted by referencing to the correspondence among the server ID, the reference frequency and the spreading code stored during the minute search 120.

Next, the control unit 14 changes the occupied bandwidth 184 and main frequency 183 of the j-th entry in the server bandwidth-in-use management table 18 to new values, and reflects (189) idle reference frequencies resulting from the latest changing of the occupied bandwidth Wj and the main frequency on the reference frequency management table 17 and the idle bandwidth management table 19. After that, the control unit 14 increments the value of the parameter j (190) and returns to Step 182.

If the value of the parameter j is exceeding the number m of the registered entries (182), the control unit 14 returns to Step 161 of the main frequency setting process 160 shown in FIG. 15 to perform the main frequency setting process 160 again from the beginning. In response to the control message transmitted by the server radio station 10A in Step 188, each of the other server radio stations updates the contents of the reference frequency management tables 17, the server bandwidth-in-use management tables 18 and the idle bandwidth management tables 19 provided therein, respectively.

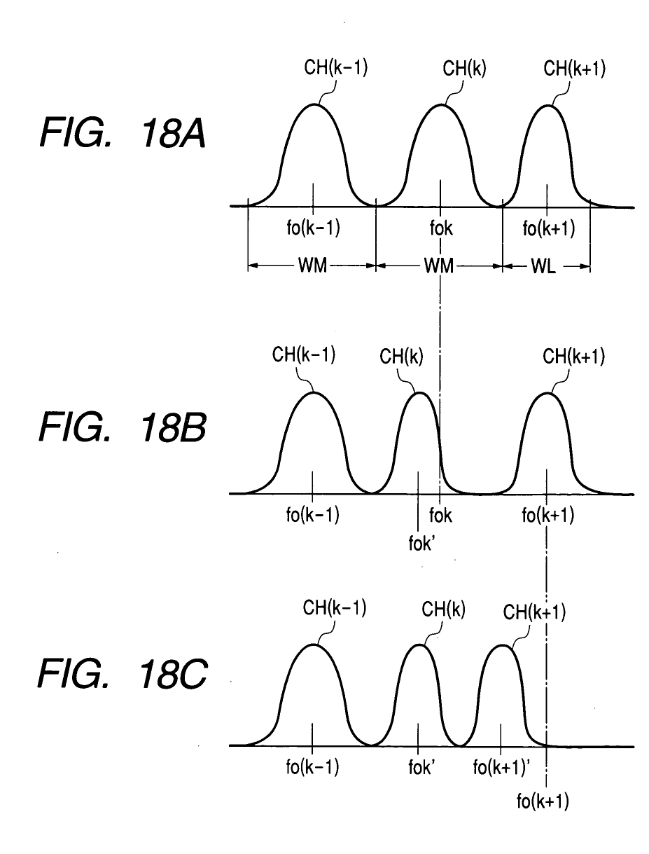

A variety of algorithms can be adopted for the allocation (188) of the main frequency to the changed occupied bandwidth Wj. In the case of using an algorithm which shifts a new occupied bandwidth Wj in the direction of the lower frequency side (or higher frequency side) of the original occupied bandwidth, the main frequency of the occupied band shifts as shown in FIGS. 18 as a result of executing the frequency band adjustment process 180.

FIG. 18A shows the state of the occupied band and the main frequency before the frequency band adjustment process 180 is executed. In the drawing, CH(k−1) represents an occupied band corresponding to the (k−1)-th entry of the server bandwidth-in-use management table 18, and CH(k) and CH(k+1) represent respective occupied bands corresponding to the k-th entry and the (k+1)-th entry of the server bandwidth-in-use management table 18. It is assumed here that the band CH (k−1) is in a state in which the main frequency and width thereof cannot be changed, while the band CH(k) has a changeable width.

FIG. 18B shows a state in which the occupied bandwidth Wj of the band CH(k) has been changed from WM to WL (184) and a main frequency f0k′ has been allocated to the occupied band in the main frequency reallocation step (187) in a processing cycle of j=k in the frequency band adjustment process 180.

FIG. 18C shows a state in which a processing cycle of j=(k+1) has been completed in the frequency band adjustment process 180. Since the width Wj of the occupied band CH(k+1) to be a processing object in this cycle is WL, the bandwidth is not changed. However, since the reallocation of the main frequency (188) is also executed for the band CH(k+1) in the frequency band adjustment process 180, the main frequency is changed from f0 (k+1) to f0 (k+1)′. In this manner, by repeating reallocation of the main frequency to each of the occupied bands such that the main frequencies shift in the direction of the lower frequency side, it is able to release the higher reference frequencies to produce a wide idle band.

Although the frequency band adjustment process 180 shown in FIG. 17 has reduced the changeable occupied bandwidths so as to shift the respective main frequencies of the occupied bandwidths in succession by repeating the same processing with respect to all the entries registered in the server bandwidth-in-use management table 18, itis also possible to, e.g. , check the idle bandwidth 193 upon each updating of the idle bandwidth management table 19 (189) , and terminate the frequency band adjustment process 180 to execute the processing subsequent to Step 165 of FIG. 15 when an idle band WAi with a width larger than the required bandwidth W is formed.

Although the main frequencies are set such that the occupied bands CH(k−1), CH(k) and CH(k+1) are consecutive in FIGS. 18, it is also possible to allocate the main frequencies such that the adjacent occupied bands have an interval corresponding to one reference frequency therebetween for complete avoidance of interference between radio signals.

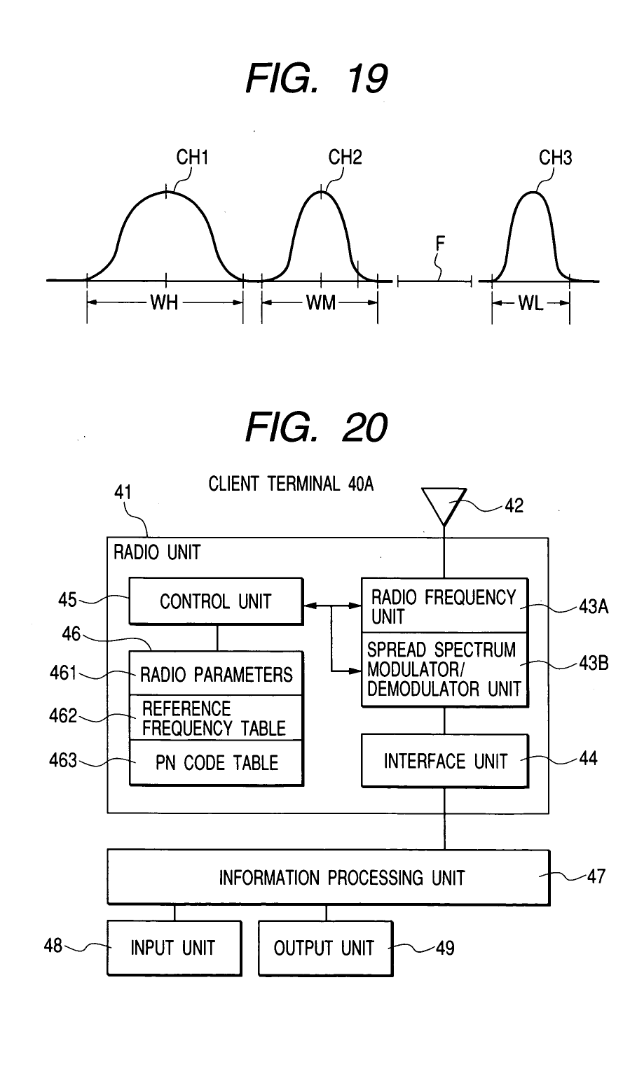

FIG. 19 shows an example of the main frequency allocation which leaves the interval corresponding to one reference frequency between the occupied bands. In the drawing, CH1, CH2, CH3, . . . represent occupied bands used in the wireless communication systems 1A, 1B, 1C, . . . according to the present invention and F represents a frequency band currently used in a wireless communication system of a type different from that of the present invention.

FIG. 20 shows an example of the client terminals 40A (40A-1, 40A-2, . . . used in the wireless communication systems according to the present invention. The client terminal 40A is comprised of a radio unit 41 and an information processing unit 47. The radio unit 41 is comprised of an RF unit 43A connected to an antenna 42, a spread spectrum modulator/demodulator unit 43B connected to the RF unit, an interface unit 44 for connection to the information processing unit 49, a control unit 45, and a nonvolatile memory 46. The spread spectrum modulator/demodulator unit 43B performs signal processing similarly to the spread spectrum modulator/demodulator unit 12B of the server radio station 10A.

The information processing unit 47 has an input unit 48 and an output unit 49 such as a display screen and is connected to the interface unit 44 in accordance with the interface specifications of, e.g., USB, PCMCIA, or the like. In the memory 46, a storage region 461 for radio parameters necessary for communication with the server radio station 10A, a reference frequency table region 462, and a PN code table region 463 are formed.

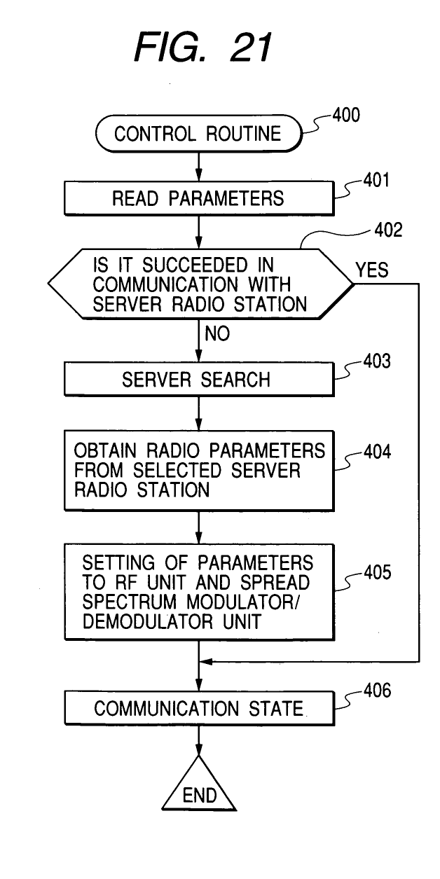

FIG. 21 shows a flow chart of a control routine 400 to be executed by the control unit 45 when the power source of the client terminal 40A is turned on.

In the control routine 400, the control unit 45 reads out the main frequency and the occupied bandwidth from the storage region 461 and reads out (401) the spreading code corresponding to the occupied bandwidth from the PN code table region 463. The control unit 45 applies these parameters to the RF unit 43A and the spread spectrum modulator/demodulator unit 43B, and proceeds straight to a communication state (406) if it has succeeded in communication with the server radio station (402).

If normal communication cannot be performed with the server radio station by using the radio parameters prepared in the storage region 461, the control unit 45 performs a server search process (403)′. In the server search process, the control unit 45 sets the reference frequencies (fb0 to fbm) stored preliminarily in the table region 462 of the memory to the RF unit 43A in succession and performs carrier sensing of surrounding radio signals for each of the reference frequencies to search a communicative server radio station. The control unit 45 performs trial communication with each of the server radio stations for which carrier has been sensed to determine an information transmission error rate and selects a server radio station of which the communication state is most excellent.

The control unit 45 having specified the server radio station to which it should belong acquires from the server radio station, radio parameters such as the occupied bandwidth and the main frequency to be used for communication with the server radio station, and rewrites the content of the storage region 461 (404). The control unit 45 adjusts the RF unit 43A at a reference frequency corresponding to the main frequency notified by the server radio station, sets the spreading code corresponding to the occupied bandwidth read out from the PN code table region 463 to the spreading code generator of the spread spectrum modulator/demodulator unit 12B (405) , and proceeds to the communication state (406)

If the necessity occurs to change the main frequency and the occupied bandwidth during the communication with the client terminal 40A as a result of the frequency band adjustment process 180 performed in another server radio station newly established, the server radio station 10A notifies each client terminal of new radio parameters after changing on all such occasions. Upon receiving the notification of the changed radio parameters, the client terminal 40A updates the effective radio parameters in the memory, changes the reference frequencies of the RF unit 43A and the spreading code of the spread spectrum modulator/demodulator unit 12B, and performs the subsequent communication with the server radio station 10A.

Even if the power source of the client terminal 40A is turned off, the radio parameters effective at that time point are held in the storage region 461 of the nonvolatile memory. Accordingly, when the power source is turned on next time, the control unit 45 can resume the communication between the client terminal and the server radio station by applying these effective radio parameters to the RF unit 43A and the spread spectrum modulator/demodulator unit 12B.

Although the description has been given thus far to the embodiment of the present invention, the present invention is not limited to the embodiment illustrated in the drawings.

For example, although the embodiment has set the use situation flag to the reference frequency management table 17 in the rough search process 110 and performed entry registration to the server bandwidth-in-use management table 18 in the minute search process 120, it is also possible to omit the rough search process 110 by executing Steps 113 to 115 of the rough search process during the minute search process, e.g., between Steps 122 and 123.

Although the main frequency of the occupied band W has been set at the center of the first-found idle band WAi satisfying the condition (W WAi) in the description of the main frequency setting process 160 illustrated in FIG. 15, it is also possible to set the main frequency such that the occupied band W is positioned at the edge of the idle band WAi in order to enlarge the remaining idle bandwidth.

To prevent the waste of the idle band remaining as a fraction as a result of setting the occupied band W, it is also possible to, e.g., store in succession the idle bands WAi each satisfying the condition (W WAi) which are found in the judgment step 163 and allocate the main frequency when the idle band WAi which satisfies W=WAi is found. In this case, if the idle band WAi satisfying W=WAi is not found eventually, it is able to select one of the stored idle bands WAi with a minimum width and allocate the main frequency to the selected idle band WAi. According to this arrangement, idle bands with a large width are left so that it is no more necessary to execute the occupied bandwidth adjustment process 170 and the frequency band adjustment process 180 in another server radio station. As a result, it becomes possible to circumvent the changing of the occupied bandwidth and the main frequency during operation.

Although the embodiment has reduced all the changeable occupied bandwidths and then shifted the main frequency of each of the occupied bands in the frequency band adjustment process 180, it is also possible to perform only the shifting of the main frequency first by omitting the reduction of the occupied bandwidths in order to enlarge the idle bandwidth while minimizing influence on another communication system, and then reduce the occupied bandwidths if an idle bandwidth adapted to the occupied bandwidth cannot be formed.

As is obvious from the foregoing description, the present invention allows the occupied band having a width satisfying a user request to be set, while avoiding the interference of radio signals between the wireless communication systems. As a result, it becomes possible to simultaneously operate a plurality of wireless communication systems by effectively using a limited frequency band.

What is claimed is:

1. A wireless communication system for performing communication within a frequency region divided into a plurality of frequency bands, comprising:
searching means for searching idle frequency bands which are not used by other wireless communication systems;
band allocating means for allocating a frequency band having a predetermined bandwidth to be used by the wireless communication system from among the idle frequency bands detected by said searching means; and
band adjusting means for adjusting the bandwidth to be occupied by the wireless communication system or any of the other wireless communication systems when said band allocating means cannot allocate the frequency band, and causing said band allocating means to perform reallocation of the frequency band.

2. A wireless communication system according to claim 1, wherein
said searching means searches reference frequencies of the frequency bands used by the other wireless communication systems and specifies reference frequencies each remaining in an idle state within said frequency region, and
said band allocating means allocates the frequency band to be used by the wireless communication system within an idle frequency band composed of a group of the idle state reference frequencies adjacent to each other.

3. A wireless communication system according to claim 1, wherein said searching means determines main frequencies of the frequency bands being used by the other wireless communication systems, inquires about frequency band information on the bands being used by the other wireless communication systems according to each of radio signals at said main frequencies, and specifies reference frequency bands in an idle state based on the frequency band information obtained from the other wireless communication systems.

4. A wireless communication system according to claim 1, wherein said band adjusting means reduces said predetermined bandwidth and performs the allocation of the frequency band to be used by the wireless communication system.

5. A wireless communication system according to claim 4, further comprising means for preliminarily holding plural types of spreading codes with different chip rates in correspondence with occupied bandwidths, wherein
said band adjusting means performs the allocation of the band reduced by selecting any of said spreading codes.

6. A wireless communication system according to claim 1, wherein
said band adjusting means enlarges an idle frequency bandwidth by shifting main frequencies of the frequency bands being used by the other wireless communication systems searched by said searching means and causes said band allocating means to perform reallocation of the frequency band to be used by the wireless communication system.

7. A wireless communication system according to claim 6, wherein said band adjusting means determines the main frequency of the frequency bands being used by one of the other wireless communication systems and enlarges the idle frequency bandwidth by requesting said one of the other wireless communication systems by using a radio signal having the main frequency to shift the main frequency of the frequency band being in use.

8. A wireless communication system according to claim 1, wherein said band adjusting means determines a main frequency of the frequency band being used by one of the other wireless communication systems, and enlarges the idle frequency bandwidth by requesting said one of the other wireless communication systems by using a radio signal having the main frequency to reduce the bandwidth being in use.

9. A wireless communication system for performing communication within a frequency region divided into a plurality of frequency bands, comprising:
a server radio station connected to a wired LAN for performing wireless communication with a plurality of client terminals and mediating communication between the individual client terminals or between each of the client terminals and the wired LAN, said server radio station having a memory for storing frequency band information indication radio frequency bands being used by the wireless communication system and other wireless communication systems; and
a server management terminal for controlling allocation of the frequency band to be used by the wireless communication system based on said frequency band information.

10. A wireless communication system according to claim 9, wherein
said frequency band information memory includes idle band information indicative of the frequency bands which are not used by the other adjacent wireless communication systems, and
said server management terminal performs the allocation of the frequency band to be used by the wireless communication system by referring to said idle band information.

11. A wireless communication system according to claim 9, wherein
said frequency band information memory indicates main frequencies of the frequency bands and occupied bandwidths being used by the plurality of the other wireless communication systems, and
said server management terminal performs the allocation of the band to be used by the wireless communication system by referring to said frequency band information.

12. A wireless communication system according to claim 11, wherein said server management terminal has means for designating a communication speed for the wireless communication system and sets the occupied bandwidth of the frequency band to be used by the wireless communication system in accordance with said designated value.

13. A wireless communication system according to claim 11, wherein said server management terminal has means for requesting a server management terminal of any of the adjacent wireless communication systems to change a frequency band being in use when the frequency band cannot be allocated to the wireless communication system, and performs the allocation of the frequency to be used by the wireless communication system based on the frequency band information that has been changed.

14. A wireless communication system according to claim 13, wherein said server management terminal has means for searching a frequency band being used by any of the other adjacent wireless communication systems and allocating the searched frequency band to said server radio station so that the server management terminal performs communication with a server management terminal of the other adjacent wireless communication system.

15. A wireless communication system according to claim 11, wherein said server management terminal has means for correcting the width of the frequency band to be used by the wireless communication system when the frequency band cannot be allocated to the wireless communication system, thereby to perform reallocation of the frequency band to the wireless communication system with the corrected bandwidth.

16. A wireless communication system according to claim 9, wherein said server management terminal performs has control means for shifting a main frequency of the frequency band being used by the wireless communication system or reducing an occupied bandwidth and updating the frequency band information on the wireless communication system in said frequency band information memory when it is requested to change the frequency band from a server management terminal of any of the other adjacent wireless communication systems.

17. A wireless communication system according to claim 16, wherein said control means notifies a client terminal connected to said server radio station of the change in the frequency band when the frequency band information on the wireless communication system is updated.

18. A wireless communication system according to claim 9, wherein said server management terminal performs the allocation of the band such that the frequency bands used by the wireless communication system and a plurality of the other wireless communication systems are not adjacent to each other.

19. A method for allocating a frequency band of a wireless communication system, the method comprising the steps of:
searching, within a predetermined frequency region divided into a plurality of frequency bands having different reference frequencies with each other, the reference frequencies currently used by other wireless systems located in the surroundings and creating a reference frequency table indicative of relationships between the reference frequencies and use situations thereof;
acquiring information on an occupied bandwidth in use from each of the other wireless communication systems located in a communicative range and creating a band-in-use management table indicative of a relationship between the occupied bandwidth and a main frequency thereof for each of the wireless communication systems;
creating an idle band management table indicative of relationships between groups of idle state reference frequencies adjacent to each other and idle frequency bands composed of the respective groups of the idle state reference frequencies based on said reference frequency table and said band-in-use management table; and
detecting one of the idle frequency bands adapted to an occupied band to be allocated to the wireless communication system from said idle band management table, and deciding a main frequency of said occupied band from among the reference frequencies in the detected idle frequency band.

20. A method according to claim 19, further comprising the step of narrowing the width of the occupied band to be allocated if the width of the occupied band is changeable when there is no idle frequency band adapted to the occupied band, wherein an idle frequency band adapted to the narrowed occupied band is detected in said main frequency deciding step.
